(19) United States
(12) Patent Application Publication
(10) Pub. No.: US 2017/0032593 A1
(43) Pub. Date: Feb. 2, 2017

(54) REMOTE WIRELESS KEYFOB DIAGNOSTICS

(71) Applicant: GM Global Technology Operations LLC, Detroit, MI (US)

(72) Inventors: Vipul M. PATEL, Northville, MI (US); Bruce D. CONNER, YPSILANTI, MI (US)

(21) Appl. No.: 14/812,617

(22) Filed: Jul. 29, 2015

(51) Int. Cl. G07C 9/00

(52) U.S. Cl. CPC G07C 9/00007; G07C 9/00309; G07C 2009/00769; G07C 2009/00984

(57) ABSTRACT

A system and method of diagnosing wireless key fob interference includes: detecting, at the vehicle, the presence of a wireless signal in a key fob frequency range; determining at least one characteristic of the detected wireless signal that prevents a vehicle user from controlling the vehicle using a wireless key fob; and determining whether interference exists.

### TECHNICAL FIELD

The present invention relates to the use of wireless keyfobs and, more particularly, resolving problems with wireless keyfobs at a remote location.

### BACKGROUND

Vehicles control access to vehicle functions using a set of keys carried by a vehicle user. In the past, mechanical keys having uniquely-shaped metal forms were received by mechanical locks that permitted vehicle access only when they recognized the unique shape of a key. However, modern vehicles commonly use wireless key fobs to control vehicle functions. Using short-range wireless signals between the vehicle key fob and the vehicle, the key fob can remotely control a number of vehicle functions. For example, when a user or vehicle owner approaches a vehicle and wants to unlock the doors, the user can depress a button on the key fob that causes the transmission of a wireless signal to the vehicle thereby unlocking the doors. Other vehicle functions can also be controlled, such as trunk opening or the flashing of exterior lights.

And in some implementations, the vehicle user may not have to push a button as part of wireless key fob operation. Vehicle functions can be controlled by a passive entry passive start (PEPS) system in which the presence of the wireless key fob within a predetermined distance of the vehicle can open vehicle locks and enable the use of vehicle ignition. The PEPS system uses a wireless key fob but may not require a user to physically input a selection for the vehicle function to be controlled. Later, when the vehicle user moves the key fob beyond the predetermined distance, the vehicle can then disable the vehicle locks and disable the vehicle ignition.

When mechanical keys fail, the vehicle user often has visual clues regarding the failure. For example, a vandal may have jammed a foreign object in the mechanical lock of a vehicle door preventing it from receiving a mechanical key. But when wireless key fobs fail to control vehicle functions, the vehicle user may have few physical clues of what is wrong. It would be helpful to diagnose unseen problems posed to the use of wireless vehicle key fobs.

### SUMMARY

According to an embodiment of the invention, there is provided a method of diagnosing wireless key fob interference. The method includes detecting, at a vehicle, the presence of a wireless signal in a key fob frequency range; determining at least one characteristic of the detected wireless signal that prevents a vehicle user from controlling the vehicle using a wireless key fob; and determining whether interference exists.

According to another embodiment of the invention, there is provided a method of diagnosing wireless key fob interference. The method includes receiving a message at a central facility indicating that a vehicle user cannot control a vehicle using a wireless key fob; initiating, at the central facility, a command instructing the vehicle to monitor a key fob frequency range for wireless signals that are present longer than a defined period of time; wirelessly transmitting the command from the central facility to the vehicle; and receiving data at the central facility from the vehicle indicating whether a wireless signal is present in the key fob frequency range for longer than the defined period of time.

According to yet another embodiment of the invention, there is provided a method of diagnosing wireless key fob interference. The method includes receiving a message at a vehicle indicating that a vehicle user cannot control the vehicle using a wireless key fob; detecting, at the vehicle, the presence of a wireless signal in a key fob frequency range in response to the received message; determining that the detected wireless signal is present for longer than a defined period of time; recording at least a portion of the detected wireless signal; detecting a vehicle location, a time the wireless signal was detected, or both; and wirelessly transmitting the recorded wireless signal along with the vehicle position, the detected time, or both to a central facility.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an implementation of a method of diagnosing wireless key fob interference.

### DETAILED DESCRIPTION OF THE ILLUSTRATED EMBODIMENTS

The system and method described below detects the existence of wireless interference that disrupts the functionality of a wireless key fob and alerts a central facility. Wireless interference with the wireless key fob may not be detected by a vehicle user who is unable to operate a vehicle using the fob. Wireless key fobs generally communicate information within a defined key fob frequency range. But the environment around the vehicle is increasingly filled with electronic devices emitting signals across wide spectrum of bandwidth. Sometimes, the electronic devices—as a result of malfunction or other cause—begin to emit wireless signals that unintentionally interfere with the wireless signals transmitted by the wireless key fob over the key fob frequency range. For example, a vehicle controlled by a wireless key fob may be parked near an electronic billboard that displays animated images using a light-emitting diode (LED) screen. The electronic billboard operation may not meet legal regulations that prevent it from interfering with wireless key fobs or may malfunction to emit signals in the key fob frequency range that disrupt wireless key fob operation.

In some environments, the vehicle user can inform the vehicle that the wireless key fob does not function properly and the vehicle can then initiate a diagnostic sequence to monitor for wireless signals that may interfere with wireless key fob operation. In other environments, the vehicle itself may monitor for interfering wireless signals without input from the vehicle user. More specifically, the vehicle can monitor the key fob frequency range for a continuously-present wireless signal or a signal that is present for longer than a defined period of time. Wireless signals communicated with the wireless key fob generally last for only a very brief period of time. In contrast, wireless signals that interfere with wireless key fob operation generally last longer than the wireless key fob signals—in some cases they are continuously present or present during certain periods of the day. By monitoring the area around the vehicle for the presence of wireless signals in the key fob frequency range, the vehicle can identify the source of signals that prevent wireless key fob functionality.

### Communications System—

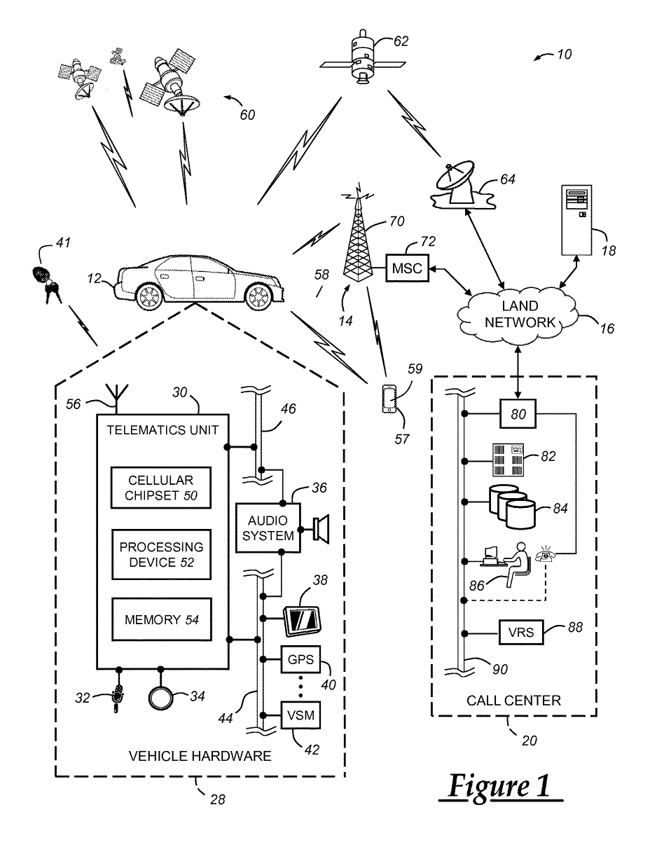

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a handheld wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface and/or a GPS module capable of receiving GPS satellite signals and generating GPS coordinates based on those signals. Examples of the smart phone 57 include the iPhone™ manufactured by Apple, Inc. and the Droid™ manufactured by Motorola, Inc. as well as others. While the smart phone 57 may include the ability to communicate via cellular communications using the wireless carrier system 14, this is not always the case. For instance, Apple manufactures devices such as the various models of the iPad™ and iPod Touch™ that include the processing capability, the display 59, and the ability to communicate over a short-range wireless communication link. However, the iPod Touch™ and some iPads™ do not have cellular communication capabilities. Even so, these and other similar devices may be used or considered a type of handheld wireless device, such as the smart phone 57, for the purposes of the method described herein.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

A wireless key fob 41 can be used with a passive entry passive start (PEPS) system that allows a vehicle user access to vehicle functionality based on the absence or presence of the key fob 41. The key fob 41 can be implemented as a handheld wireless device that includes a microprocessor and an antenna capable of communicating wireless signals over a short distance (e.g., <50 meters) and located within a housing. In some configurations, the key fob 41 may be a dedicated device solely used to control vehicle functions, like opening vehicle doors, flashing exterior lights, and enabling the ignition switch of the vehicle 12. However, it is also possible that the wireless key fob 41 can be integrated with other multi-function handheld consumer electronic devices that offer additional functionality and are capable of communicating using short-range wireless protocols. The wireless key fob 41 can wirelessly communicate with vehicle electronics 28 using wireless signals transmitted in the key fob frequency range. This range can depend on the technology used to implement the PEPS system. In one implementation, the key fob frequency range can be implemented at 315 Mhz or 434 Mhz, or 868 Mhz each having a range of +/−250 khz. However, it should be appreciated that these frequency ranges are only examples what is possible and the methods disclosed herein can also be implemented using other frequency bands.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

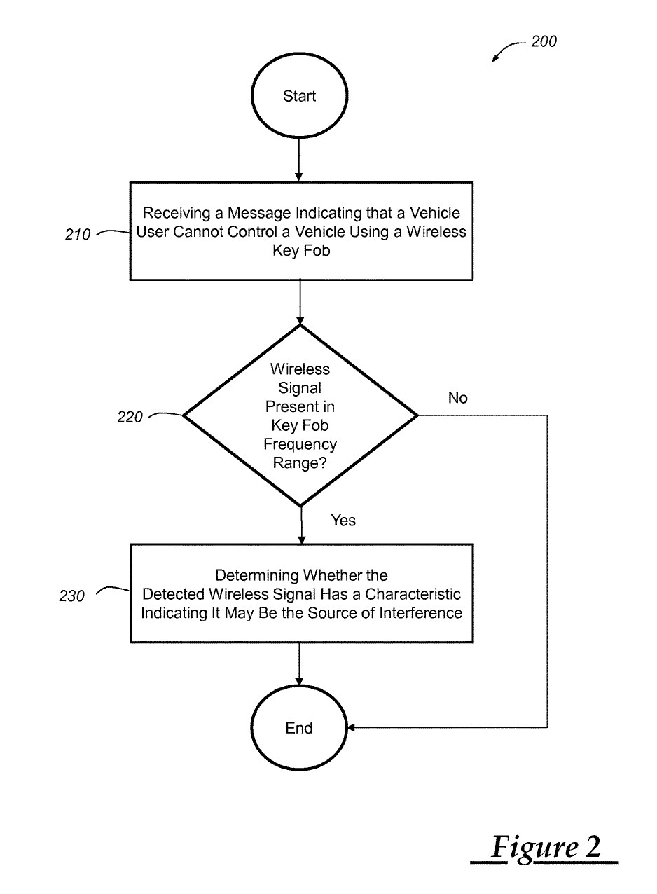

Turning now to FIG. 2, there is shown an implementation of a method 200 of diagnosing wireless key fob interference that begins at step 210 by receiving a message indicating that a vehicle user cannot control the vehicle 12 using the wireless key fob 41. This message can be communicated from a vehicle user to a central facility, such as the computer 18 or call center 20, verbally during a telephone call or in text format using SMS or other electronic messaging. When the vehicle user is unable to access the vehicle 12, the vehicle user can use communication mechanisms that are separate from the vehicle 12 to contact the central facility. These communications facilities can involve the smart phone 57 that places cellular telephone calls or a tablet that can communicate text messages via Wi-Fi. However, if the vehicle user can enter the vehicle 12 (e.g., unlock the doors) but is unable to start it, the vehicle user may be able to contact the central facility using the vehicle telematics unit 30. After receiving information that the wireless key fob 41 for the vehicle 12 is not operating, the central facility can then identify the vehicle 12 associated with the vehicle user and contact the vehicle 12 with an instruction to monitor for interfering wireless signals in the key fob frequency range. In some configurations, the vehicle user may be able to send the message to begin monitoring from the smart phone 57 directly to the vehicle telematics unit 30 using short-range wireless protocols.

For instance, the vehicle user can place a telephone call to the call center 20 seeking assistance getting into the vehicle 12 when the wireless key fob 41 does not work. The call center 20 can then identify the vehicle 12 that is associated with the vehicle user and initiate a command instructing the vehicle 12 to monitor a key fob frequency range for wireless signals that are present longer than a defined period of time. The command can include computer-executable instructions that when received by the vehicle electronics 28 causes the vehicle 12 to monitor the key fob frequency range. The vehicle telematics unit 30 can receive the command, execute the command using processor 52, and then begin monitoring the key fob frequency range via the antenna 56. While method 200 has been described with respect to a vehicle user initially determining that the key fob 41 does not work, the method 200 can also be implemented such that the vehicle 12 can detect wireless key fob interference without vehicle user assistance or initiation.

Different elements of the vehicle electronics 28 can be designated for monitoring the key fob frequency range. In one implementation, the VSM 42 that is configured as a body control module can implement the PEPS system and include its own microprocessor and antenna. The body control module may be tasked with receiving wireless signals from the key fob 41 and also monitoring the key fob frequency range for other signals. However, other PEPS system implementations are possible. For instance, the PEPS system can be implemented using a receiving module that is separate from the VSM 42 but communicatively linked to the VSM 42 using a dedicated data bus. The separate module can include an antenna and a microprocessor that demodulates data received via the module antenna. The data can then be sent to the BCM over a dedicated data bus. The method 200 proceeds to step 220.

At step 220, the presence of a wireless signal in a key fob frequency range is detected at the vehicle 12 in response to the received message. When the vehicle 12 begins monitoring the key fob frequency range, it can first identify the appropriate key fob frequency range that will be monitored. The vehicle 12 can then monitor for the presence of wireless signals in that frequency range. In one embodiment, the key fob frequency range can extend from 300-400 Mhz. However, it should be appreciated that other frequency ranges could be used with the method 200 as well.

A period of signal monitoring can begin and extend long enough for the vehicle 12 to detect periodic or non-constant signals that interfere with the wireless key fob 41. When the period of signal monitoring begins, the source of interfering wireless signals may not be active. Thus, the period of signal monitoring can extend over a 24 hour period, a 7 day period, or even longer to detect the sporadic existence of a wireless signal in the key fob frequency range. For instance, a neighbor's nearby landscape lighting may be a possible source of wireless signals that interfere with the wireless key fob. In this example, if the vehicle user reported an inoperative key fob 41 during daylight hours, the vehicle 12 may begin monitoring for interfering wireless signals and not detect the source of the problem. When the monitoring period extends over 24 hours, the vehicle 12 can detect the interfering wireless signals when the arrival of darkness coincides with the use of landscape lighting. Longer monitoring periods may be helpful as well. Sometimes, the vehicle 12 may be parked near an entertainment district of a city that brings increased traffic and activity on certain days of the week. When activity spikes on certain days of the week (e.g., Saturday), the vehicle 12 may be instructed to monitor for extended periods of time to capture this reality. The vehicle 12 may not detect a wireless signal in the key fob frequency range. When that occurs, the vehicle 12 can alert the central facility that the vehicle 12 did not detect wireless signals in the key fob frequency range. The central facility can then determine that the functionality of the wireless key fob 41 is not affected by interfering wireless signals. On the other hand, once the vehicle 12 detects the presence of a wireless signal in the key fob frequency range, the method 200 proceeds to step 230.

At step 230, it is determined whether the detected wireless signal has a characteristic indicating it may be the source of interference, such as frequency, amplitude (signal strength), or that the signal is present for longer than a defined period of time. A properly functioning wireless key fob 41 may generate wireless signals within the key fob frequency range having a relatively brief duration (e.g., <100 milliseconds). For example, a key fob 41 may transmit for a period of 20-35 ms (on time, transmit) then wait for 65 to 80 ms (off time, no transmission) and then repeat the cycle. With this in mind, once the vehicle 12 detects a wireless signal in the key fob frequency range for longer than a defined time, such as >100 milliseconds, it can then initiate a counter that monitors the length to time the wireless signal is present. The value at the counter may then be compared with the defined period of time beyond which the presence of the signal indicates that it is interfering with the wireless key fob 41. The defined period of time can be established as a value that is longer than any signal transmitted by the wireless key fob 41 or PEPS system. An exemplary value for this period may be 5 seconds, however, this value may be adjusted based on the frequency range used by the key fob or different configurations of the PEPS system.

When the detected wireless signal is measured for longer than the defined period of time, the vehicle 12 can alert the vehicle user, the central facility, or both. This alert can be transmitted directly to the vehicle user via a short-range wireless message between the vehicle telematics unit 30 and a handheld wireless device carried by the vehicle user. But in addition to or in lieu of transmitting the alert to the vehicle user using short-range wireless protocols, the vehicle telematics unit 30 can transmit the alert to the central facility, which may or may not contact the vehicle user. The vehicle 12 can also carry out a number of additional actions besides transmitting alerts about the presence of an interfering signal. For example, the vehicle 12 can record the interfering signal and store the recording in the memory device 54 at the vehicle 12 for later transmission to the central facility. The vehicle 12 can also record the time of day the vehicle 12 detected the interfering signal or the location where the vehicle 12 detected the signal. The data resulting from these additional actions can then be wirelessly transmitted from the vehicle 12 to the central facility.

By gathering additional data regarding the detected interfering signal, such as a recording of the interfering signal, the location of the signal, and/or the time it exists, the central facility can then monitor this data over time and identify trouble more readily. For instance, the signal recordings can be used to identify sources of signal interference and shed light on what types of devices most commonly cause interference with the wireless key fob. Also, the central facility can monitor locations known to cause trouble and even note the most likely time the trouble could occur. This information can be used at the central facility to respond to other vehicle users who may experience wireless key fob failure. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of diagnosing wireless key fob interference, comprising the steps of:
(a) detecting, at a vehicle, the presence of a wireless signal in a key fob frequency range;
(b) determining at least one characteristic of the detected wireless signal that prevents a vehicle user from controlling the vehicle using a wireless key fob; and
(c) determining whether interference exists based on step (b).

2. The method of claim 1, further comprising the step of informing the vehicle user that wireless key fob interference exists.

3. The method of claim 1, further comprising the step of receiving a message from the vehicle user when the vehicle user cannot use the key fob.

4. The method of claim 3, wherein the message is received at the vehicle.

5. The method of claim 1, wherein step (c) comprises determining that the interference exists based on the detected wireless signal being present for longer than a defined period of time.

6. The method of claim 1, further comprising the step of wirelessly transmitting an alert message from the vehicle to a central facility in response to step (b).

7. The method of claim 1, further comprising the step of recording the detected wireless signal and wirelessly transmitting the recording to a central facility.

8. The method of claim 1, further comprising the step of recording the time and location the wireless signal was detected and wirelessly transmitting the time and location to a central facility.

9. A method of diagnosing wireless key fob interference, comprising the steps of:
(a) receiving a message at a central facility indicating that a vehicle user cannot control a vehicle using a wireless key fob;
(b) initiating, at the central facility, a command instructing the vehicle to monitor a key fob frequency range for wireless signals that are present longer than a defined period of time;
(c) wirelessly transmitting the command from the central facility to the vehicle; and
(d) receiving data at the central facility from the vehicle indicating whether a wireless signal is present in the key fob frequency range for longer than the defined period of time.

10. The method of claim 9, further comprising the step of transmitting a message from the central facility to the vehicle user indicating that wireless key fob interference exists.

11. The method of claim 9, wherein the central facility is a call center.

12. The method of claim 9, further comprising the step of wirelessly receiving at the central facility a recording of the wireless signal present in the key fob frequency range for longer than the defined period of time.

13. The method of claim 9, further comprising the step of wirelessly receiving at the central facility the time and location the wireless signal was recorded.

14. A method of diagnosing wireless key fob interference, comprising the steps of:
(a) receiving a message at a vehicle indicating that a vehicle user cannot control the vehicle using a wireless key fob;
(b) detecting, at the vehicle, the presence of a wireless signal in a key fob frequency range in response to the received message;
(c) determining that the detected wireless signal is present for longer than a defined period of time;
(d) recording at least a portion of the detected wireless signal;
(e) detecting a vehicle location, a time the wireless signal was detected, or both in response to step (c); and
(f) wirelessly transmitting the recorded wireless signal along with the vehicle position, the detected time, or both to a central facility.

15. The method of claim 14, further comprising the step of informing the vehicle user that wireless key fob interference exists.

16. The method of claim 14, wherein the message is transmitted from the central facility.

17. The method of claim 14, wherein the central facility is a call center.
